(19) United States
(12) Patent Application Publication
(10) Pub. No.: US 2010/0010979 A1
(43) Pub. Date: Jan. 14, 2010

(54) Reduced Volume Precision Data Quality Information Cleansing Feedback Process

(75) Inventors: Steven Garfinkle, Cold Spring, NY (US); Akram Boughannam, Lake Worth, FL (US); Jamshid Abdollahi Vayghan, North Oaks, MN (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/172,071

(22) Filed: Jul. 11, 2008

(51) Int. Cl. G06F 7/00

(52) U.S. Cl. 707/4

(57) ABSTRACT

This invention provides methods and computer program products for a reduced volume precision data quality information cleansing feedback process. More specifically, a method according to one embodiment of the invention receives a request from a user for information from an electronic information warehouse. In response to the request, the information is transmitted to the user. Feedback is received from the user, wherein the feedback includes errors in content of the information and errors in relationship data. The relationship data has data describing how a data entry in the information relates to other data entries in the information. The feedback also includes proposals on how to correct the errors in the content and the errors in the relationship data. In another embodiment, the user is prompted for feedback.

### I. FIELD OF THE INVENTION

This invention relates to a data warehousing method and system, and more specifically, to a method and system that cleans and prioritizes data for a data warehouse.

### II. BACKGROUND OF THE INVENTION

Most data warehousing projects consolidate data from different source systems, each of which typically will be using a different data organization and/or format, whether the data is relevant or of interest to the end-users. Common data source formats include relational databases, flat files, and non-relational database structures such as information management system (IMS), virtual storage access method (VSAM), indexed sequential access method (ISAM), DB2 (relational) and flat files (XML) structures. The current approach to creating a data warehouse is to extract the data from a variety of sources, to transform the data from the original source to a form for the data warehouse, and to load the data into the data warehouse. To facilitate the transformation of the data, predetermined rules are used, and typically the predetermined rules do not get the transformation right because data is excluded or incorrectly transformed. The predetermined rules are setup using data profile surveys, but not based on user requirements. This results in a high cost for the transformation, which is only sent higher by the desire to move as much data over as possible and can be obtained for extraction.

### III. SUMMARY OF THE INVENTION

This invention provides methods and computer program products for a reduced volume precision data quality information cleansing feedback process. More specifically, a method according to one embodiment of the invention receives a request from a user for information from an electronic information warehouse. In response to the request, the information is transmitted to the user. Feedback is received from the user, wherein the feedback includes errors in content of the information and errors in relationship data. The relationship data has data describing how a data entry in the information relates to other data entries in the information. The feedback also includes proposals on how to correct the errors in the content and the errors in the relationship data. In another embodiment, the user is prompted for feedback.

Furthermore, the method according to one embodiment of the invention creates correction rules based on the feedback and monitors information request behavior patterns to identify selected types of information by the user and non-selected types of information by the user. The information contained in the information warehouse is modified using the correction rules to produce modified information, wherein the modifying reduces the volume of the information. The modification of the information removes the non-selected types of information and only process relevant transactional data to build a data warehouse. Thus, the modification of the information only processes relevant data for analysis.

The method, according to one embodiment of the invention, displays the modified information to the user. Further, alerts are sent to a data quality operations team, wherein the alerts include the correction rules. A response to the alerts is received from the data quality operations team, wherein the response includes an acceptance, rejection and/or modification of the correction rules. In one embodiment of the invention, the alerts are sent before the information is modified; in another embodiment, the alerts are sent after the information is modified.

Moreover, the method, according to one embodiment of the invention, receives additional feedback from the user and/or an additional user. The correction rules are updated based on the additional feedback to produce updated correction rules. The updating of the correction rules adds and/or removes rules from the correction rules. Further, the modified information is updated using the updated correction rules to produce updated modified information. The method also stores the information in a data warehouse and updates the data warehouse by replacing the information with the modified information.

### IV. BRIEF DESCRIPTION OF THE DRAWINGS

The present invention is described with reference to the accompanying drawings. In the drawings, like reference numbers indicate identical or functionally similar elements.

FIG. 1A is a diagram illustrating one embodiment of an automated information cleansing and data quality feedback loop;

FIG. 1B is a diagram illustrating another embodiment of an automated information cleansing and data quality feedback loop;

FIG. 2 is a diagram illustrating a logical architecture flow;

FIG. 3 is a flow diagram illustrating one embodiment of a reduced volume precision data quality information cleansing feedback process;

FIG. 4 is a flow diagram illustrating another embodiment of a reduced volume precision data quality information cleansing feedback process; and

FIG. 5 is a diagram of a computer program product according to at least one embodiment of the invention.

### V. DETAILED DESCRIPTION OF THE DRAWINGS

One embodiment of the invention combines services oriented architecture (SOA), subject matter expertise and rules driven technology to deliver an optimized approach in maintaining and building trusted information for business intelligence. This framework enables the creation and delivery of quality information warehouses at lower costs and at faster rates then is currently possible. As discussed below, the cleansing process reduces the volume of information contained in the information warehouse and only processes relevant transactional data. By combining this framework with end-user expertise and translating rules into embedded web services, this system streamlines and optimizes information repository builds. This illustrative embodiment places a strong focus on web interaction, analysis of requested information, and the ability of end-users to influence what they know to be valid. In at least one embodiment, provided inputs are translated into dynamic rules in the form of “feedback” instructions that drive the data refresh, build, and cleansing processes. This enables an enterprise to build information warehouses selectively instead of having to process every single transaction. This selective process capability ultimately reduces the cost and the time needed to build and maintain information warehouses.

In at least one embodiment of the invention, published and subscribed web services are used to implement alerts and process rules that are solicited directly from the user community as opposed to standard IT processes of requirements gathering and internal development work. This illustrative embodiment supports “Information on Demand” from three perspectives: 1) providing an automated tool, 2) providing a process methodology and 3) leveraging subject matter expertise through an implemented active feedback loop.

End users submit requests for business intelligence or information from web connected applications using pervasive and non pervasive computing devices. These requests are processed through enterprise mash-up applications or other web based user interfaces (UI) that are enabled with logic to receive information requests, dispatch XML based web services that monitor information requests and collect parameter driven rules to influence how the information is constructed and refreshed on a scheduled or real time basis.

In at least one embodiment of the invention, the ability to issue alerts when changes to data content are requested is included. This information in at least one embodiment is transmitted to other systems and to data quality operations personnel that can react to the requested changes. By enriching the information warehouse build with external rules that are driven by subject matter experts and end-users, the process is optimized from a cost, speed and volume perspective. Enterprises no longer need to process every possible available transaction to deliver trusted information sources. Different embodiments of the invention provide capabilities to analyze information requested along with user driven correction rules to reconstruct how the information sources get built and updated.

Different embodiments of this invention include at least one of the following features: connections to Information Sources, instructions for Information Retrieval, dynamically constructed user driven specifications for information source builds, Publish/Subscribe web services to control dynamic build rules, Publish/Subscribe web services for triggering alerts, ability to collect feedback from user communities to drive and optimize the information build process, and ability to improve data quality by associating rules dynamically from subject matter experts.

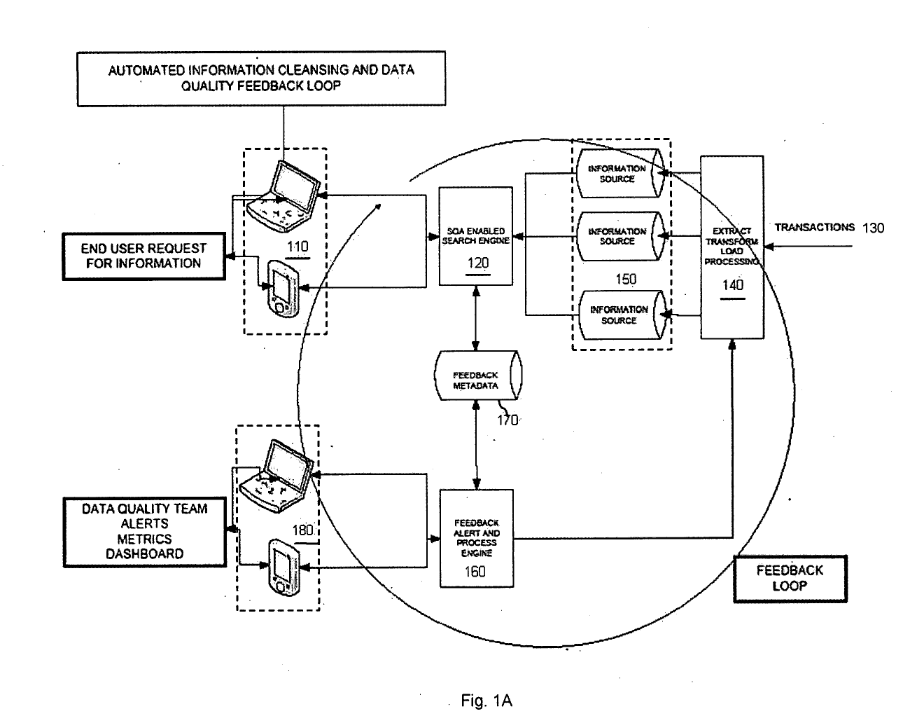

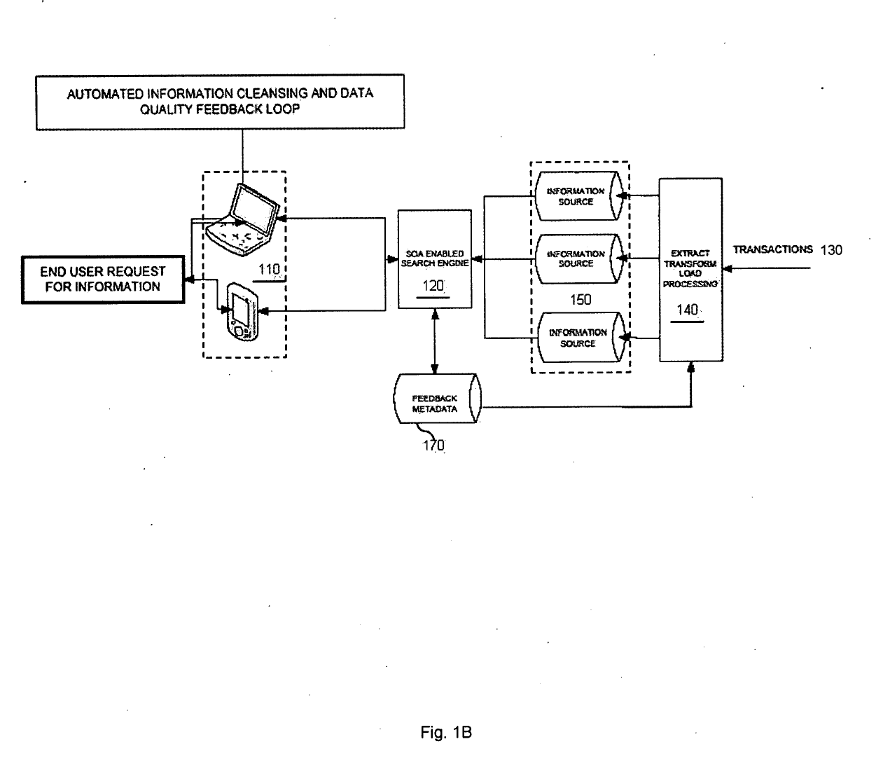

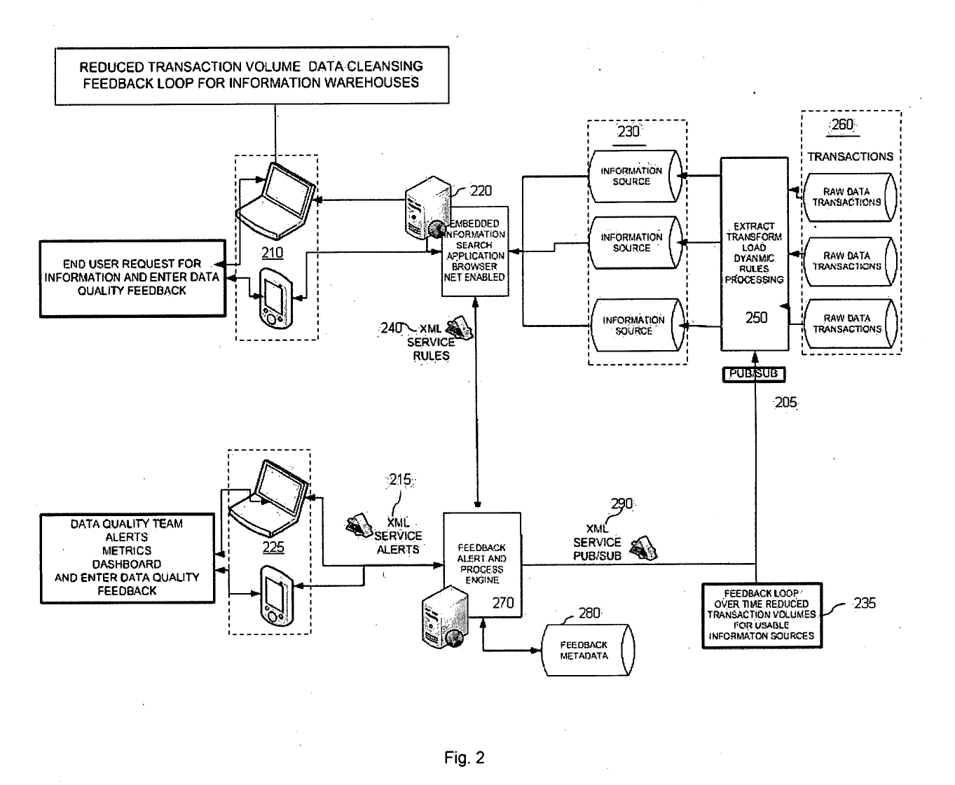

FIGS. 1A-2 illustrate embodiments according to the invention. FIGS. 1A and 1B are diagrams illustrating different embodiments of an automated information cleansing and data quality feedback loop. More specifically, through internet connected pervasive and non pervasive computing devices 110, an end user submits a request for business intelligence metrics and information analytics to an SOA enabled search engine 120 that pulls the requested information from information source containers 150. Raw data transactions 130 are input into a processing component 140, which drives the extract, transform and load processes that are required to harvest the raw transactional data 130 and turn it into usable information stored in the information source containers 150. The information source containers 150 are used to house information accessed during the request for business intelligence metrics and information analytics. The information source containers 150 refer to data warehouse or data marts, or any source of enterprise data that is used as a repository of information, such as revenue, orders, product, customer, or a blend of data, etc. A feedback alert and processing engine 160 takes in process rules and information request behavior patterns. This information is stored in the feedback metadata container 170. The feedback metadata container 170 houses all the annotations and rules stemming from end-user interaction with the data. Such information is stored to build services and process the required transactions.

In at least one embodiment, as illustrated in FIG. 1A, through internet connected pervasive and non pervasive computing devices 180, a data quality operations team interacts and monitor the feedback rules that are being driven by the end-user community. Accordingly, the feedback loop illustrated in FIG. 1A reduces transaction volumes required to keep information sources up-to-date per data warehousing processes. This includes information transform rules that are established via end-user input and brokered by web services.

In another embodiment of the invention, as illustrated in FIG. 1B, the data quality operations team is omitted from the automated information cleansing and data quality feedback loop. In such an embodiment, the feedback metadata container 170 connects directly to the processing component 140. It is contemplated in yet another embodiment that publish and subscribe web service implementations (similar to Pub/Sub 205 in FIG. 2) are utilized to drive optimized rules for refreshing the information sources in information source containers 150. Moreover, the data quality operations team is utilized after the transform rules are implemented. In such an embodiment, the process does not have to wait for input from the data quality operations team before performing the transform operation. A circular arrow (or loop) is utilized in FIG. 1A to illustrate a feedback loop. Specifically, feedback is received from end users and utilized to create rules that modify data in the warehouse. The rules and modified data are sent to a data quality team for review.

FIG. 2 illustrates another embodiment according to the invention. More particularly, FIG. 2 illustrates the flow of information through the system that includes raw data sources, end user interfaces, data quality control, and feedback loop. The flow of information through the illustrated embodiment will be discussed in the following paragraphs.

First, requests for business intelligence metrics and information analytics are issued through internet connected pervasive and non pervasive computing devices 210, for example, from user requests or software calls. This activity can occur for any information domain where electronically stored information is preprocessed, cleansed, transformed and subsequently loaded into databases 230 known as data marts, data cubes or information warehouses. Requests are sent to web enabled applications as noted below. Results are then returned to the requesting interfaces.

Once information requests are received, the requests are parsed, analyzed and subsequently converted by information search application 220 into retrieval instructions for needed information and data stored in databases 230. In addition to requesting preprocessed information, in at least one embodiment of the invention, a feedback alert and process engine 270 (described in more detail below) monitors the type of transactions that the requests are focusing on. This is done to help determine which types of information are being queried versus which types are not. This information will be used in subsequent information warehouse builds to help reduce the amount of data processed and/or prioritize the data. In addition to monitoring and recording the types of information requests being made, the end-users in at least one embodiment are also prompted to indicate anomalies in the information they are viewing. This information is routed to a storage area using, for example, XML based web services.

Furthermore, information source containers 230 are used to house information accessed during requests for business intelligence and other information analytics. A variety of formats can be used, such as relational, flat, and cube. The containers 230 are created from collecting raw transactional data from systems such as order entry, inventory, and customer information capture systems. Web service rules 240 (also referred to herein as “correction rules”) are created to enrich the information in containers 230. Specifically, the web service rules 240 are created by analyzing data that is being requested and feedback received from end-users. The system looks for repeated patterns of usage and based on the requests being made, a statistical model is maintained within the metadata container to optimized builds based on data usage.

As described below, these rules are stored in the “FEEDBACK METADATA” container 280. Extract, transform and load processes required to harvest raw transactional data and turn it into usable information which would be subsequently used to drive business decisions and influence business processes are performed by processor 250. Rules stored in the “FEEDBACK METADATA” container 280 are used to build publish and subscribe rules to drive the information build process performed by processor 250.

The data containers 230 store inbound raw data transactions 260 that can be of any type or domain. As described below, these transactions are used as input. The feedback alert and process engine 270 performs a server process that takes in process rules and information request behavior patterns wrapped in, for example, XML messages, Real Simple Syndication (RSS), Java Script Object notation, Simple Object Access Protocol (SOAP), Atom, or any user defined messaging format, as web services.

This process also publishes processing rules that are subscribed to by an “Extract, Transform, Load and Dynamic Rules Processing Engine” (not shown). This information is also stored in the “FEEDBACK METADATA” container 280 described below. As also described below, XML contained web service alerts 215 are triggered from the feedback alert and process engine 270. These service alerts are used to indicate issues with the information being viewed. These alerts would be used to drive data quality monitoring dashboards that either people or systems would be the recipient of.

A data repository, or FEEDBACK METADATA” container, 280 is used to retain information from the feedback alert and process engine 270. Further, publish and subscribe web service implementations are performed by an XML Service Pub/Sub 290 to drive optimized rules for refreshing the information sources.

A Pub/Sub component 205 indicates that a publish and subscribe web service process has been implemented to drive the dynamic rules that are used to influence which data gets transformed. This also includes any subject matter expert rules that are entered through the user interfaces 210. Moreover, XML based web services 215 that contain alert messages that are emitted from the feedback alert and process engine 270 are identified.

Through internet connected pervasive and non pervasive computing devices 225, a data quality operations team interacts and monitors with feedback rules that are being driven by the end-user community. The feedback loop concept 235 reduces transaction volumes required to keep information sources up to date per data warehousing processes. This includes information transform rules that are established via end-user input and brokered by web services.

The data warehousing software in at least one embodiment is shared, simultaneously serving multiple customers in a flexible, automated fashion. It is standardized, requiring little customization and it is scalable, providing capacity on demand such as in a pay as-you-go model.

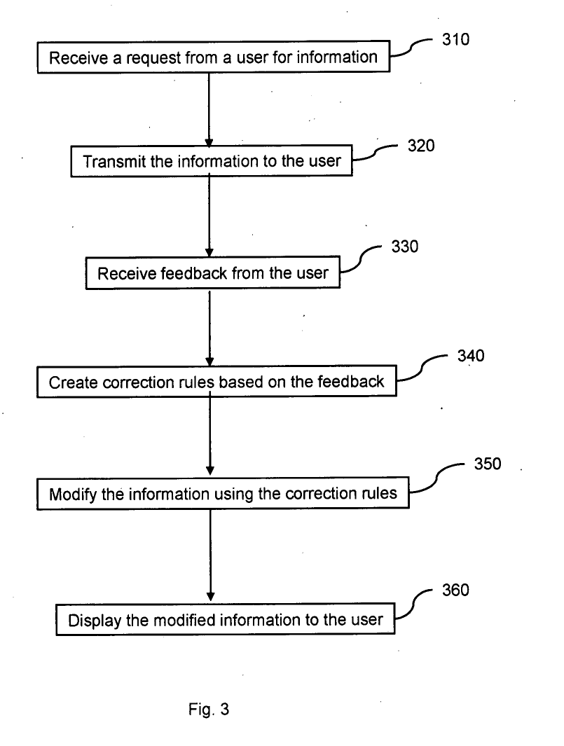

FIG. 3 is a flow diagram illustrating one embodiment of a reduced volume precision data quality information cleansing feedback process. More specifically, a request from a user for information from an electronic information warehouse is received (310); and, the requested information is transmitted to the user (320). Feedback (also referred to herein as “subject matter expert rules”) is received from the user (330), wherein the feedback includes, for example, errors in content of the information and errors in relationship data. The relationship data has data describing how a data entry in the information relates to other data entries in the information. As discussed above, the end-users, in at least one embodiment, are prompted to indicate anomalies in the information they are viewing. This information is routed to a storage area, for example, using XML based web services. In another embodiment, the process monitors the type of transactions that the requests are focusing on.

Correction rules are created based on the feedback (340). As discussed above, the feedback is translated into dynamic rules that drive the data refresh, build, and cleansing processes. This enables an enterprise to build information warehouses selectively instead of having to process every single transaction. The information is modified using the correction rules to produce modified information (350), wherein the modification reduces the volume of the information. This selective process capability ultimately reduces the cost and the time needed to build and maintain information warehouses. In at least one embodiment, the modified information is displayed to the user (360).

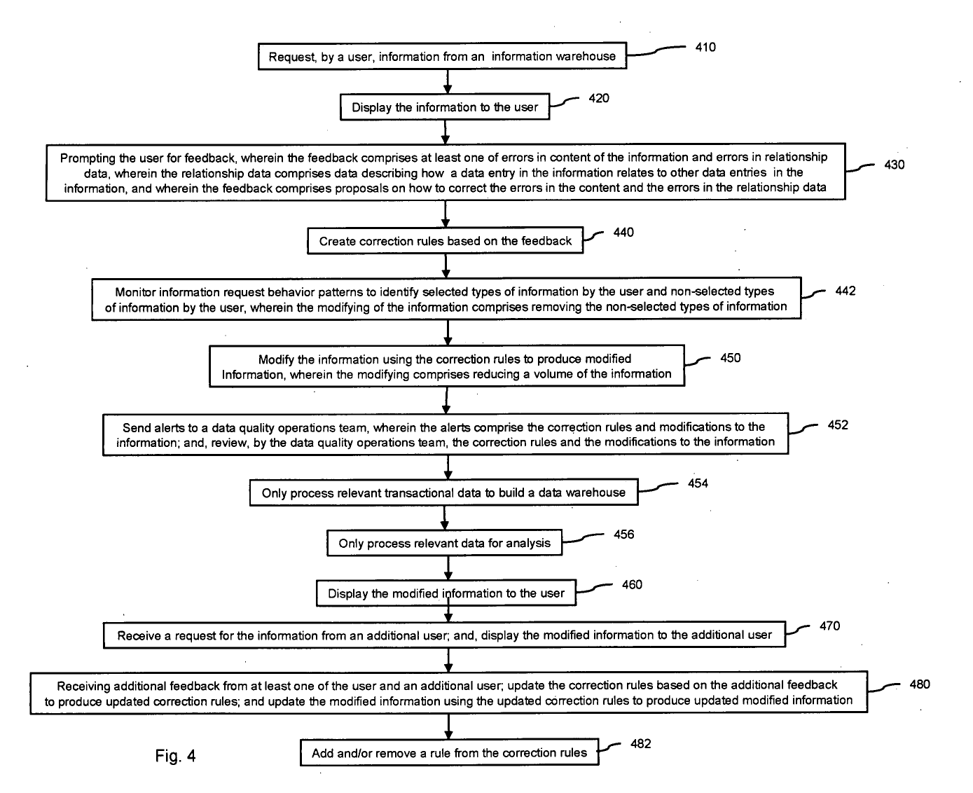

FIG. 4 is a flow diagram illustrating another embodiment of a reduced volume precision data quality information cleansing feedback process. A user requests information from an electronic information warehouse (410). The information is displayed to the user (420); and, the user is prompted for feedback (430). The feedback includes, for example, errors in content of the information and errors in relationship data. The relationship data contains data describing how a data entry in the information relates to other data entries in the information. Moreover, the feedback includes proposals on how to correct the errors in the content and the errors in the relationship data. As discussed above, the end-users are prompted to indicate anomalies in the information they are viewing. This information is routed to a storage area, for example, using XML based web services.

Correction rules are created based on the feedback (440). As discussed above, the feedback is translated into dynamic rules that drive the data refresh, build, and cleansing processes. This enables an enterprise to build information warehouses selectively instead of having to process every single transaction. The process monitors information request behavior patterns to identify selected types of information by the user and non-selected types of information by the user (450). This is done to help determine which types of information are being queried versus which types are not. This information will be used in subsequent information warehouse builds to help reduce the amount of data processed. Specifically, the non-selected types of information are removed when modifying and/or updating the information.

The information is modified using the correction rules to produce modified information (450). The modification reduces a volume of the information. This selective process capability ultimately reduces the cost and the time needed to build and maintain information warehouses. After modifying the information, alerts are sent to a data quality operations team (452). The alerts include the correction rules and modifications to the information. As described above, published and subscribed web services are used to implement alerts and process rules that are solicited directly from the user community as opposed to standard IT processes of requirements gathering and internal development work. The data quality operations team reviews the correction rules and the modifications to the information.

The modifying of information only processes relevant transactional data to build a data warehouse (454). Moreover, the modification of information only processes relevant data for analysis (456). As discussed above, the feedback loop reduces transaction volumes required to keep information sources up-to-date per data warehousing processes. This includes information transform rules that are established via end-user input and brokered by web services.

The modified information is displayed to the user (460). The process further includes receiving a request for the information from an additional user; and displaying the modified information to the additional user (470). Additionally, the process receives additional feedback from the user and/or an additional user and updates the correction rules based on the additional feedback to produce updated correction rules (480). Furthermore, the modified information is updated using the updated correction rules to produce updated modified information. As discussed above, rules stored in the “FEEDBACK METADATA” container are used to build publish and subscribe rules to drive the information build process.

The updating of the correction rules adds and/or removes rules from the correction rules (482). As discussed above, by enriching the information warehouse build with external rules that are driven by subject matter experts and end-users, the process is optimized from a cost, speed and volume perspective. Enterprises no longer need to process every possible available transaction to deliver trusted information sources.

At least one embodiment of the invention takes the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, at least one embodiment of the invention takes the form of a computer program product accessible from a computer-usable or computer-readable medium providing program code for use by or in connection with a computer or any instruction execution system. For the purposes of this description, a computer-usable or computer readable medium is any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

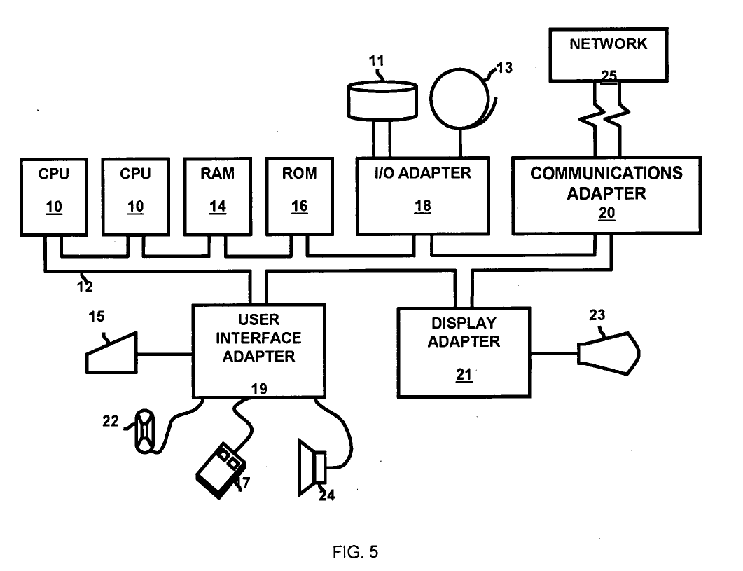

A representative hardware environment for practicing at least one embodiment of the invention is depicted in FIG. 5. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 connects to peripheral devices, such as disk units 11 and tape drives 13, or other program storage devices that are readable by the system. The system reads the inventive instructions on the program storage devices and follows these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method, comprising:
receiving a request from a user for information from an information warehouse;
transmitting said information to said user in response to said request;
receiving feedback from said user, wherein said feedback comprises at least one of errors in content of said information and errors in relationship data, wherein said relationship data comprises data describing how a data entry in said information relates to other data entries in said information;
creating correction rules based on said feedback; and
modifying said information using said correction rules to produce modified information, wherein said modifying comprises reducing a volume of said information.

2. The method according to claim 1, further comprising displaying said modified information to said user.

3. The method according to claim 1, further comprising monitoring information request behavior patterns to identify selected types of information by said user and non-selected types of information by said user, wherein said modifying of said information further comprises removing said non-selected types of information.

4. The method according to claim 1, further comprising:
sending alerts to a data quality operations team, wherein said alerts comprise said correction rules; and
receiving a response to said alerts from said data quality operations team.

5. The method according to claim 1, further comprising:
receiving additional feedback from at least one of said user and an additional user;
updating said correction rules based on said additional feedback to produce updated correction rules; and
updating said modified information using said updated correction rules to produce updated modified information.

6. The method according to claim 5, wherein said updating of said correction rules comprises at least one of adding a rule and removing a rule from said correction rules.

7. The method according to claim 1, further comprising:
storing said information in a data warehouse; and
updating said data warehouse by replacing said information with said modified information.

8. The method according to claim 1, wherein said feedback comprises proposals on how to correct said errors in said content and said errors in said relationship data.

9. The method according to claim 1, wherein said modifying of said information comprises only processing relevant transactional data to build a data warehouse.

10. The method according to claim 1, wherein said modifying of said information comprises only processing relevant data for analysis.

11. A method, comprising:
receiving a request from a user for information from an information warehouse;
transmitting said information to said user in response to said request;
prompting said user for feedback;
receiving said feedback from said user, wherein said feedback comprises at least one of errors in content of said information and errors in relationship data, wherein said relationship data comprises data describing how a data entry in said information relates to other data entries in said information;
creating correction rules based on said feedback;
monitoring information request behavior patterns to identify selected types of information by said user and non-selected types of information by said user;
modifying said information using said correction rules to produce modified information, wherein said modifying comprises reducing a volume of said information, and wherein said modifying of further comprises removing said non-selected types of information; and
displaying said modified information to said user.

12. The method according to claim 11, further comprising:
sending alerts to a data quality operations team, wherein said alerts comprise said correction rules; and
receiving a response to said alerts from said data quality operations team, wherein said response comprises at least one of acceptance, rejection and modification of said correction rules.

13. The method according to claim 11, further comprising:
receiving additional feedback from at least one of said user and an additional user;
updating said correction rules based on said additional feedback to produce updated correction rules; and
updating said modified information using said updated correction rules to produce updated modified information.

14. The method according to claim 13, wherein said updating of said correction rules comprises at least one of adding a rule and removing a rule from said correction rules.

15. The method according to claim 11, further comprising:
storing said information in a data warehouse; and
updating said data warehouse by replacing said information with said modified information.

16. A method, comprising:
receiving a request from a user for information from an information warehouse;
transmitting said information to said user in response to said request;
prompting said user for feedback;
receiving said feedback from said user, wherein said feedback comprises at least one of errors in content of said information and errors in relationship data, wherein said relationship data comprises data describing how a data entry in said information relates to other data entries in said information;
creating correction rules based on said feedback;
sending alerts to a data quality operations team, wherein said alerts comprise said correction rules;
receiving a response to said alerts from said data quality operations team, wherein said response comprises at least one of acceptance, rejection and modification of said correction rules;
monitoring information request behavior patterns to identify selected types of information by said user and non-selected types of information by said user;
modifying said information contained in said information warehouse using said correction rules to produce modified information, wherein said modifying comprises removing said non-selected types of information;
reducing a volume of said information contained in said information warehouse; and
displaying said modified information to said user.

17. The method according to claim 16, further comprising:
receiving additional feedback from at least one of said user and an additional user;
updating said correction rules based on said additional feedback to produce updated correction rules; and
updating said modified information using said updated correction rules to produce updated modified information.

18. The method according to claim 17, wherein said updating of said correction rules comprises at least one of adding a rule and removing a rule from said correction rules.

19. The method according to claim 16, further comprising:
storing said information in a data warehouse; and
updating said data warehouse by replacing said information with said modified information.

20. A computer program product comprising computer readable program code stored on computer readable storage medium embodied therein for performing a method, comprising:
receiving a request from a user for information from an information warehouse;
transmitting said information to said user in response to said request;
receiving feedback from said user, wherein said feedback comprises at least one of errors in content of said information and errors in relationship data, wherein said relationship data comprises data describing how a data entry in said information relates to other data entries in said information;
creating correction rules based on said feedback; and
modifying said information using said correction rules to produce modified information, wherein said modifying comprises reducing a volume of said information.

21. The computer program product according to claim 20, further comprising displaying said modified information to said user.

22. The computer program product according to claim 20, further comprising monitoring information request behavior patterns to identify selected types of information by said user and non-selected types of information by said user, wherein said modifying of said information further comprises removing said non-selected types of information.

23. The computer program product according to claim 20, further comprising:
sending alerts to a data quality operations team, wherein said alerts comprise said correction rules; and
receiving a response to said alerts from said data quality operations team.

24. The computer program product according to claim 20, further comprising:
receiving additional feedback from at least one of said user and an additional user;
updating said correction rules based on said additional feedback to produce updated correction rules; and
updating said modified information using said updated correction rules to produce updated modified information.

25. The computer program product according to claim 24, wherein said updating of said correction rules comprises at least one of adding a rule and removing a rule from said correction rules.
